(19) United States
(12) Patent Application Publication
(10) Pub. No.: US 2016/0215204 A1
(43) Pub. Date: Jul. 28, 2016

(54) VISCOELASTIC FLUID

(71) Applicant: THE LUBRIZOL CORPORATION, Wickliffe, OH (US)

(72) Inventors: Zen-Yu Chang, Conroe, TX (US); James D. Burrington, Gates Mills, OH (US)

(21) Appl. No.: 14/915,412

(22) PCT Filed: Sep. 10, 2014
(86) PCT No.: PCT/US2014/054882

§ 371 Date: Feb. 29, 2016

Related U.S. Application Data
(60) Provisional application No. 61/875,856, filed on Sep. 10, 2013.

(51) Int. Cl. C09K 8/64; E21B 43/26; E21B 7/00; C09K 8/34

(52) U.S. Cl. CPC C09K 8/64; C09K 8/34; E21B 43/26; E21B 7/00

(57) ABSTRACT

The present technology relates to gelling agents that can be employed in preparing organic-based viscoelastic fluids. The technology additionally relates to methods of using such gelling agents and viscoelastic fluids containing the gelling agents in energy and exploration applications.

### BACKGROUND OF THE INVENTION

The present technology relates to gelling agents that can be employed in preparing organic-based viscoelastic fluids. The technology additionally relates to methods of using such gelling agents and viscoelastic fluids containing the gelling agents in energy and exploration applications.

The ability to modify fluid rheology is important in many industries. For example, drilling muds in oil-based drilling applications is one application in which control of fluid rheology is helpful. One of the functions of a drilling fluid is to carry drilling cut out of a wellbore. The viscosity of the drilling fluid provides the solid carrying power needed to remove the cut. Often, organophilic clays are used in oil-based drilling fluids to provide the needed viscosity. One drawback to the use of organophillic clays for building viscosity in oil-based drilling is that viscosity development is slow. The slow development of viscosity can result in overdosing problems.

Another purpose for modifying fluid rheology is for modifying the drag resulting from transporting a fluid.

Fluid rheology can also be important in creating stable suspensions. For example, in hydraulic fracturing applications there is often a need to form stable guar gum slurries. Current commercially available guar gum slurries involving organophillic clay as the suspending aid are not generally stable in terms of phase separation upon storage without some sort of agitation or circulation. However, the guar gum could be damaged by the constant shearing of agitation or re-circulation.

It would be an improvement in the art to provide a viscoelastic thickening fluid and method of use of such fluid which would be capable of thickening fluids used in many different applications, which would thicken fluids under temperature and environmental conditions typically encountered in the particular application and which would provide an alternative to existing thickening agents.

### SUMMARY OF THE INVENTION

The disclosed technology provides a gelling agent that can act as a viscosifier and suspending agent, can be employed for rheology control, as a stabilizer for dispersions, as a dispersant, as a lubricant, as a promoter, and the like.

In one embodiment, there is provided a viscoelastic fluid. The viscoelastic fluid can comprise an I) organic medium, and II) a gelling agent.

The gelling agent in turn can comprise a) an organic compound capable of forming a chelate with a Lewis acid, b) a Lewis acid, and c) a basic compound, and/or the reaction product of the a), b) and c) mixture.

In an embodiment, the organic compound can be chosen from at least one of: i) an organic hydroxy acid, and hydrocarbyl substituted derivatives thereof, or ii) an aromatic polyol, such as benzene diol, and hydrocarbyl substituted derivatives thereof, or iii) combinations of i) and ii). The organic hydroxy acid can comprise two or more oxygen atoms and hydrocarbyl substituted derivatives thereof. The organic hydroxy acid is capable of forming a chelate with a Lewis acid. Example hydroxy acids include salicylic acid, tartaric acid and hydrocarbyl substituted derivatives thereof.

The Lewis acid can have a formula of MXₙ, where M is chromium (Cr), boron (B), aluminum (Al), titanium (Ti), silicon (Si), zirconium (Zr), or zinc (Zn), X is a an alkoxy, hydroxyl, halogen, or hydrocarbyl halide group, and n is an integer required to complete the valence of the Lewis acid, generally from about 1 to 10. Typical Lewis acids can include, but not be limited to, tri-alkylborates; boric acid; boron tri-halides; and aluminum halides.

The basic compound can be selected to cause the gelling agent to gel when in contact with the organic medium. An example of a basic compound can be an organic amine, such as a polyamine, including hydrocarbyl substituted amines and hydroxylamines, or alkylether amines.

The organic compound, (for example, organic hydroxy acid or aromatic polyol), Lewis acid, and basic compound can be included in the gelling agent together at a molar ratio of about 0.1-10 to about 1 to about 0.1-10. The gelling agent itself can be present in the organic medium from about 0.01 to about 25 weight percent based on the total weight of the viscoelastic fluid.

The viscoelastic fluid can also contain III) further additives, such as, for example, a viscosity promoting filler, such as an organophillic clay, or hydratable polymers.

The viscoelastic fluid can be employed, for example, in a method of fracturing a subterranean formation. The viscoelastic fluid can be provided and pumped through a wellbore and into a subterranean formation at sufficient pressures to fracture the formation.

The viscoelastic fluid can also be employed, for example, in a method of drilling a wellbore. The viscoelastic fluid can be provided and pumped into the wellbore at sufficient pressures to carry a drilling cut out of the wellbore.

The viscoelastic fluid can also be employed for controlling the rheology of an organic medium, and/or preventing flocculation in a heterogeneous composition comprising an organic medium and a suspended additive.

### DETAILED DESCRIPTION OF THE INVENTION

Various preferred features and embodiments will be described below by way of non-limiting illustration.

There is provided a viscoelastic fluid. The viscoelastic fluid includes an organic medium and a gelling agent.

The organic medium in the viscoelastic fluid can be any organic medium and is typically a fluid having a predominantly hydrocarbon nature, but non-hydrocarbon organic mediums are also contemplated organic media. Organic media can be artificially categorized, for example, as oils, organic solvents, fuels and fuel oils, and combinations thereof, although it is to be understood that there will be substantial overlap between the categories.

Nonetheless, oils suitable to prepare the viscoelastic fluid can include, for example, natural and synthetic oils, oil derived from hydrocracking, hydrogenation, and hydrofinishing, unrefined, refined and re-refined oils and mixtures thereof.

Unrefined oils are those obtained directly from a natural or synthetic source generally without (or with little) further purification treatment, for example, crude oil or black oil, or a non-volatile fraction from a distillation of a crude oil.

Refined oils are similar to the unrefined oils except they have been further treated in one or more purification steps to improve one or more properties. Purification techniques are known in the art and include solvent extraction, secondary distillation, acid or base extraction, filtration, percolation and the like.

Re-refined oils are also known as reclaimed or reprocessed oils, and are obtained by processes similar to those used to obtain refined oils and often are additionally processed by techniques directed to removal of spent additives and oil breakdown products.

Natural oils useful in making the inventive lubricants include animal oils, vegetable oils (e.g., castor oil), mineral lubricating oils such as liquid petroleum oils and solvent-treated or acid-treated mineral lubricating oils of the paraffinic, naphthenic or mixed paraffinic-naphthenic types and oils derived from coal or shale or mixtures thereof.

Synthetic lubricating oils are useful and include hydrocarbon oils such as polymerized and interpolymerized olefins (e.g., polybutylenes, polypropylenes, propyleneisobutylene copolymers); poly(l-hexenes), poly(loctenes), poly(l-decenes), and mixtures thereof; alkyl-benzenes (e.g., dodecylbenzenes, tetradecylbenzenes, dinonylbenzenes, di-(2-ethylhexyl)benzenes); polyphenyls (e.g., biphenyls, terphenyls, alkylated polyphenyls); diphenyl alkanes, alkylated diphenyl alkanes, alkylated diphenyl ethers and alkylated diphenyl sulphides and the derivatives, analogs and homologs thereof or mixtures thereof.

Other synthetic lubricating oils include polyol esters (such as Priolube™ 3970), diesters, liquid esters of phosphorus-containing acids (e.g., tricresyl phosphate, trioctyl phosphate, and the diethyl ester of decane phosphonic acid), or polymeric tetrahydrofurans. Synthetic oils may be produced by Fischer-Tropsch reactions and typically may be hydroisomerised Fischer-Tropsch hydrocarbons or waxes. In one embodiment oils may be prepared by a Fischer-Tropsch gas-to-liquid synthetic procedure as well as other gas-to-liquid oils.

Oils of lubricating viscosity may also be defined as specified in the American Petroleum Institute (API) Base Oil Interchangeability Guidelines. The five base oil groups are as follows: Group I (sulphur content>0.03 wt %, and/or <90 wt % saturates, viscosity index 80-120); Group II (sulphur content.1toreq.0.03 wt %, and .gtoreq.90 wt % saturates, viscosity index 80-120); Group III (sulphur content. 1toreq.0.03 wt %, and .gtoreq.90 wt % saturates, viscosity index.gtoreq.120); Group IV (all polyalphaolefins (PAOs)); and Group V (all others not included in Groups I, II, III, or IV). The oil of lubricating viscosity comprises an API Group I, Group II, Group III, Group IV, Group V oil or mixtures thereof. Often the oil of lubricating viscosity is an API Group I, Group II, Group III, Group IV oil or mixtures thereof. Alternatively the oil of lubricating viscosity is often an API Group II, Group III or Group IV oil or mixtures thereof.

Other types of organic media can include organic solvents, such as, for example, aliphatic, unsaturated and aromatic hydrocarbons, C₈ or higher alcohols, glycols, and glycol ethers, as well as C₈ or high ethers, esters, amides and the like.

Fuels suitable for preparing the viscoelastic fluid are not particularly limited. The fuel can be a hydrocarbon fuel, a nonhydrocarbon fuel, or a mixture thereof. The fuel can be a petroleum distillate, including a gasoline as defined by ASTM specification D4814, or a diesel fuel as defined by ASTM specification D975. The hydrocarbon fuel may be a heavy fuel such as a heavy distillate heating oil or marine/industrial fuel oil, including bunker fuel. The hydrocarbon fuel can be a hydrocarbon prepared by a gas to liquid process to include for example hydrocarbons prepared by a process such as the Fischer-Tropsch process. The nonhydrocarbon fuel can be an oxygen containing composition, often referred to as an oxygenate, to include an alcohol, an ether, a ketone, an ester of a carboxylic acid, a nitroalkane, or a mixture thereof. The nonhydrocarbon fuel can include for example methanol, ethanol, methyl t-butyl ether, methyl ethyl ketone, transesterified oils and/or fats from plants and animals such as rapeseed methyl ester and soybean methyl ester, and nitromethane. Mixtures of hydrocarbon and nonhydrocarbon fuels can include for example gasoline and methanol and/or ethanol, diesel fuel and ethanol, and diesel fuel and a transesterified plant oil such as rapeseed methyl ester. In an embodiment of the invention the liquid fuel is an emulsion of water in a hydrocarbon fuel, a nonhydrocarbon fuel, or a mixture thereof.

In one embodiment the organic medium can be an oil field product, e.g. a whole well product or a multiphase mixture in or from a well bore, or one at a well head after at least partial separation of gas and/or water, for instance, an oil export fraction. In one embodiment the organic medium can be a refinery or petrochemical process stream or a heavy distillate or residual fuel.

The viscoelastic fluid also contains a gelling agent. The gelling agent includes an organic compound capable of forming a chelate with a Lewis acid, or “organic compound” for short; at least one Lewis acid; and at least one basic compound. In one embodiment, the gelling agent can be the reaction product of an organic compound, at least one Lewis acid, and at least one basic compound. In another embodiment, the gelling agent can be the reaction product of an organic compound, at least one Lewis acid, and at least one basic compound, and/or the reaction product thereof; that is, the gelling agent can include the ingredients individually, it can also include the reaction product resulting from the mixture of ingredients, or it can contain a combination of the two.

The gelling agent includes an organic compound capable of forming a chelate with a Lewis acid. The term “chelate” is used herein in its generally accepted sense, meaning a compound containing a ligand bonded to a central atom with coordinate bonds. Thus, organic compounds are those that can donate a pair of electrons and form coordinate bonds with the Lewis acid. In an example embodiment, the organic compound can be chosen from at least one of, i) organic hydroxy acids, ii) aromatic polyols, or iii) combinations of i) and ii).

The hydroxy acid can be represented by the formula (OH)(R)R¹—(COOH)ₓ, where x is 1 to 3, R may be an alkyl or alkenyl group of from 1 to 12 carbon atoms, or 1 to 10 carbon atoms, or 1 to 6 or 8 carbon atoms and R¹ can be a hydrocarbyl substituent on R. As an alkyl group R can be straight chain, branched or cyclic and as an alkenyl R can be straight chain, branched or cyclic, aliphatic or aromatic. R can also include one or more heteroatoms in place of a carbon atom, such as nitrogen, phosphorus, and sulfur, so long as R maintains at least 1 to 4 carbon atoms. The hydroxy acid can be α-, β-, γ- or mixtures thereof, and can include a single carboxylic acid moiety, such as in glycolic acid, or multiple carboxylic acid moieties, such as in tartaric acid, both of which are suitable for the viscoelastic fluid. Another suitable hydroxy acid can be salicylic acid. Further examples of a suitable hydroxy acid include lactic acid, citric acid, mandelic acid, hydroxybutyrate, and carnatine. In one embodiment the hydroxyl acid comprises or consists of α-hydroxy acids. In one embodiment the hydroxy acid comprises or consists of β-hydroxy acids. In one embodiment the hydroxy acid comprises or consists of γ-hydroxy acids. In one embodiment the hydroxy acid can exclude α-hydroxy acids. In one embodiment the hydroxy acid can exclude β-hydroxy acids. In one embodiment the hydroxy acid can exclude γ-hydroxy acids.

Aromatic polyols can be represented by the formula:

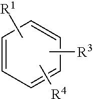

where R³ and R⁴ can be OH or an alkyl or alkenyl group of from 1 to 12 carbon atoms, or 1 to 10 carbon atoms, or 1 to 6 or 8 carbon atoms; and R¹ can be H or a hydrocarbyl substituent. Aromatic polyols can include, but not be limited to, for example, benzendiols, such as, catechol, resorcinol and hydroquinone. In one embodiment, the aromatic polyol can be catechol and in a similar embodiment the aromatic polyol can be a hydrocarbyl substituted catechol.

As noted, the organic compound, such as, for example, the hydroxy acid and/or aromatic polyol, can also be substituted with a hydrocarbyl substituent, R¹. As used herein, the term “hydrocarbyl substituent” or “hydrocarbyl group” is used in its ordinary sense, which is well-known to those skilled in the art. Specifically, it refers to a group having a carbon atom directly attached to the remainder of the molecule and having predominantly hydrocarbon character. Examples of hydrocarbyl groups include: hydrocarbon substituents, including aliphatic, alicyclic, and aromatic substituents; substituted hydrocarbon substituents, that is, substituents containing non-hydrocarbon groups which, in the context of this invention, do not alter the predominantly hydrocarbon nature of the substituent; and hetero substituents, that is, substituents which similarly have a predominantly hydrocarbon character but contain other than carbon in a ring or chain. A more detailed definition of the term “hydrocarbyl substituent” or “hydrocarbyl group” is found in paragraphs [0137] to [0141] of published application US 2010-0197536.

The hydrocarbyl substituent on the organic compound, e.g., hydroxy acid or aromatic polyol group, may contain from 1 to 32 carbon atoms, or from 1 to 26 or 1 to 18 carbon atoms. The hydrocarbyl substituent may also contain an average of at least about 8, or at least about 20, or at least about 30, or at least about 35 carbon atoms up to about 350, or up to about 200, or up to about 100 carbon atoms.

An example hydrocarbyl substituent can include, for example, polyalkenes. The polyalkene may be characterized by an Mn (number average molecular weight) of at least about 500. The polyalkene may be characterized by an Mn of at least about 500, or at least about 700, or at least about 800, or at least about 900 up to about 5000, or up to about 2500, or up to about 2000, or up to about 1500. In one embodiment, Mn may vary from about 500, or about 700, or about 800, to about 1200 or about 1300. In one embodiment, the polydispersity (Mw/Mn) may be at least about 1.5.

The polyalkenes may include homopolymers and inter-polymers of polymerizable olefin monomers of 2 to 16 carbon atoms, or 2 to 6 carbon atoms, or 2 to 4 carbon atoms. The olefins may be monoolefins such as ethylene, propylene, 1-butene, isobutene, and 1-octene; or a polyolefinic monomer, such as diolefinic monomer, such 1,3-butadiene and isoprene. In one embodiment, the inter-polymer may be a homo-polymer. An example of a polymer that may be used is polybutene. In one embodiment, about 50% of the polybutene may be derived from isobutylene. The polyalkenes may be prepared by conventional procedures.

In some embodiments, the organic compound can be dimerized or trimerized and employed as the dimer or trimer. The organic compound can be dimerized or trimerized, for example, by reaction with a suitable linking agent, such as compounds with an available oxygen or sulfur atom, as well as by employing various Friedel Crafts acylations or alkylations, or by using different metal catalysts like the Heck reaction or Suzuki coupling, which are well-known to those of ordinary skill in the art. A suitable linking agent can include, but not be limited to, formaldehyde. In one embodiment, the organic compound capable of forming a chelate with a Lewis acid can be a formaldehyde coupled dimer of an organic hydroxy acid, such as, for example, a formaldehyde coupled dimer of salicylic acid, which can, in one embodiment, be represented by Formula I below. In another embodiment, the organic compound capable of forming a chelate with a Lewis acid can be a formaldehyde coupled dimer of an aromatic polyol, such as, for example, a formaldehyde coupled catechol dimer, which can, in one embodiment, be represented by Formula II below. In further embodiments, the organic compound capable of forming a chelate with a Lewis acid can be a mixed dimer or trimer of at least two or more different organic compounds, such as, for example, two different organic hydroxy acids or two different aromatic polyols, or even the combination of at least one organic hydroxy acid and at least one aromatic polyol.

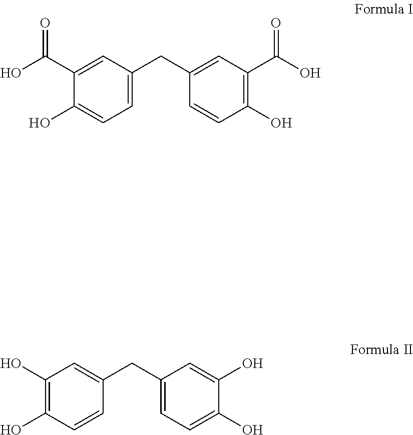 [SMILES: O=C(O)c1cc(Cc2ccc(O)c(C(=O)O)c2)ccc1O ; Oc1ccc(Cc2ccc(O)c(O)c2)cc1O]

The gelling agent also includes at least one Lewis acid. The Lewis acids suitable for use in the gelling agent are not particularly limited and can be any chemical species that can accept an electron pair, which one of ordinary skill would readily recognize. Simple cations may be employed in the gelling agent as a Lewis acid, as can any atom or compound with an incomplete octet of electrons, or compounds with a central atom that can have more than eight valence shell electrons.

For practical purposes the Lewis acid can be represented by the formula MXₙ, where “M” can be, for example, chromium (Cr), boron (B), aluminum (Al), titanium (Ti), silicon (Si), zirconium (Zr), zinc (Zn), and the like, and “X” can be, for example, an alkoxy (e.g., ROR, where R is a hydrocarbyl group), hydroxyl (e.g., ROH, where R is a hydrocarbyl group), a halogen or hydrocarbyl halide group (e.g., F, Cl, Br, I, or RF, etc., where R is a hydrocarbyl group). “n” is simply the integer required to ensure the valence of M is filled to the extent possible between M and X. For example, in AlCl₃ n is 3, which fills the valence of Al to the extent possible between Al and Cl.

Some examples of Lewis acids include tri-alkylbroates [B(OR)₃], such as tri(2-ethylhexyl) borate; boric acid [B(OH)₃], or its various condensed derivatives, such as meta-boric acid; boron tri-halides such as BF₃, BCl₃, BClBr₂, BBr₃, and BBrCl₂; and aluminum halides such as AlCl₃, AlClBr₂, AlBr₃, and AlBrCl₂.

The gelling agent also contains at least one basic compound. The basic compound is selected so as to cause the gelling agent to gel when in contact with the organic medium. Without being bound by theory, it is believed the mechanism of gelling relates to the formation of a micellar network of the gelling medium, wherein the anions formed by chelation of the hydroxy acid chelated to the central atom of the Lewis acid, and cations composed of the conjugate acid of the base, act as a surfactant in an extended network of an emulsified medium. The formation of this gelling agent complex usually requires a certain level of insolubility of the gelling agent in the oil. If the gelling agent is too soluble in the oil, solubilization will be preferred to emulsion formation, and if the solubility is too low, gelation will not occur because the gelling agent will form a separate phase in preference to an emulsion.

The basic compound can comprise an anion which forms a volatile compound upon acidification. The basic compounds thus can include conventional bases such as hydroxides or oxides (producing water upon acidification), as well as basic salts such as acetates (producing acetic acid), other alkanoates, and carbonates and bicarbonates (producing carbon dioxide). Volatile compounds may be defined, for the purpose of the present invention, as those which exhibit a significant vapor pressure at room temperature and which can be removed from a solution, if desired, by evaporation, optionally with heating or under vacuum. Volatile materials generally have a boiling point at atmospheric pressure of 130° C. or less, preferably 100° C. or less, more preferably 70° C. or less. Most preferably they are gases at room temperature.

The basic compound can generally be a metal, ammonium (NH₄⁺), or amine (NR₄⁺) compound, such as an alkali metal, alkaline earth metal, ammonium, or amine salt. In an example embodiment, the cation can be lithium, sodium, potassium, calcium, or magnesium, so that the basic compound can be a lithium, sodium, potassium, calcium, or magnesium compound.

Notwithstanding the foregoing description, the basic compound is not particularly limited. Some examples of the basic compounds are lithium carbonate, lithium hydroxide, sodium hydroxide, sodium carbonate, sodium bicarbonate, potassium carbonate, potassium bicarbonate, calcium carbonate, calcium hydroxide, magnesium carbonate, and magnesium hydroxide, although any appropriate metal compound may be employed as the cation.

Other examples of suitable basic compounds can include, for example, amines, which includes polyamines, such as di-, tri- and higher polyamines, as well as alkylether amines. The amines can be substituted or un-substituted aliphatic or aromatic amines containing from 1 to 36 carbon atoms, or 1 to 26 carbon atoms, or 1 to 12 or 18 or 20 carbon atoms. The amines can also be substituted with a hydroxyl group, meaning a nitrogen atom in the amine can be functionalized with an OH group. Other examples include compounds containing basic amine functionality such as those present in ashless lubricant dispersants such as polyisobutenyl succinimides and antioxidants such as alkylate diphenyl amines.

Ashless dispersants are so-called because, as supplied, they do not contain metal and thus do not normally contribute to sulfated ash when added to a lubricant. However they may, of course, interact with ambient metals in a mixture which includes metal-containing species. Ashless dispersants are characterized by a polar group attached to a relatively high molecular weight hydrocarbon chain. Typical ashless dispersants include N-substituted long chain alkenyl succinimides, having a variety of chemical structures including typically

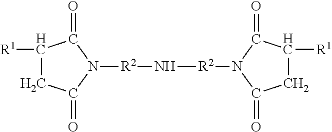

where each R¹ is independently an alkyl group, frequently a polyisobutylene group with a molecular weight of 500-5000, and R² are alkylene groups, commonly ethylene (C₂H₄) groups. Such molecules are commonly derived from reaction of an alkenyl acylating agent with a polyamine, and a wide variety of linkages between the two moieties is possible beside the simple imide structure shown above, including a variety of amides and quaternary ammonium salts. Also, a variety of modes of linkage of the R¹ groups onto the imide structure are possible, including various cyclic linkages. The ratio of the carbonyl groups of the acylating agent to the nitrogen atoms of the amine may be 1:0.5 to 1:3, and in other instances 1:1 to 1:2.75 or 1:1.5 to 1:2.5. Succinimide dispersants are more fully described in U.S. Pat. Nos. 4,234,435 and 3,172,892 and in EP 0355895.

Another class of ashless dispersant is Mannich bases. These are materials which are formed by the condensation of a higher molecular weight, alkyl substituted phenol, an alkylene polyamine, and an aldehyde such as formaldehyde. Such materials may have the general structure

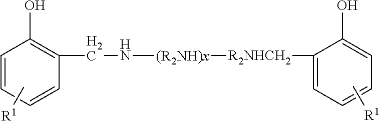

(including a variety of isomers and the like) and are described in more detail in U.S. Pat. No. 3,634,515.

Antioxidants can include aromatic amines, and often a diarylamine, of the formula

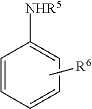

wherein R⁵ is a phenyl group or a phenyl group substituted by R⁷, and R⁶ and R⁷ are independently a hydrogen or an alkyl group containing from 1 up to 24 carbon atoms. In certain embodiments, R⁵ is a phenyl group substituted by R⁷, and R⁶ and R⁷ are alkyl groups containing 4 to 20 or 6 to 16 or 8 to 12 or 8 to 10 carbon atoms, or, in some embodiments, about 9 carbon atoms. In some embodiments R⁶ is an alkyl group as described and R⁷ is hydrogen, and in some embodiments there is a mixture of materials in which R⁷ is H in some molecules and is an alkyl group in other molecules.

In one embodiment, the aminic anti-oxidant comprises an alkylated diphenylamine such as nonylated diphenylamine of the formula

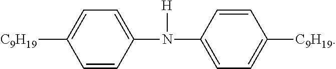

Mixtures of the mono- and di-C₉ substituted materials are commonly used. Other aminic antioxidants include N-phenyl-α-naphthylamine, N-phenyl-β-naphthylamine, tetramethyldiaminodiphenylmethane, anthranilic acid, phenothiazine, 4-(phenylamino)phenol, and akylated derivatives of any of the foregoing, the alkyl (or hydrocarbyl) groups typically having sufficient length to impart a measure of oil solubility.

Specific examples of aminic antioxidants include monoalkyldiphenyl amines such as monooctyldiphenyl amine and monononyl diphenyl amine; dialkyldiphenyl amines such as 4,4′-dibutyldiphenyl amine, 4,4′-dipentyldiphenyl amine, 4,4′-dihexyldiphenyl amine, 4,4′-diheptyldiphenyl amine, 4,4′-dioctyldiphenyl amine and 4,4′-dinonyldiphenyl amine; polyalkyldiphenyl amines such as tetra-butyldiphenyl amine, tetrahexyldiphenyl amine, tetra-octyldiphenyl amine, and tetra-nonyldiphenyl amine; the naphthylamines such as α-naphthylamine and phenyl-α-naphthylamine; butylphenyl-α-naphthylamine, pentylphenyl-α-naphthylamine, hexylphenyl-α-naphthylamine, heptylphenyl-α-naphthylamine, octylphenyl-α-naphthylamine, and nonylphenyl-α-naphthylamine. Of these, dialkyldiphenyl amines and naphthylamines are commonly used.

The organic hydroxy acid, Lewis acid and basic compound can be present in the gelling agent at a molar ratio of from about 0.1 to about 10 organic hydroxy acid, to about 1 Lewis acid, to about 0.1 to about 10 basic compound. In another embodiment, the molar ratio can be from about 0.5 to about 3, to about 1, to about 0.5 to about 3, or from about 1 to about 2, to about 1, to about 1 to about 2, such as 2 to 1 to 1.

The gelling agent can be included in the viscoelastic fluid from about 0.01 to about 25 weight percent, based on the combined weight of both the organic medium and the gelling agent. In another embodiment, the gelling agent can be present at about 0.02 to about 15 weight percent, or about 0.05 to about 10 weight percent, or even 0.1 to about 5 weight percent, based on the combined weight of both the organic medium and the gelling agent.

The viscoelastic fluid can be employed for a variety of purposes. For example, the viscoelastic fluid can be employed for rheology control, as a stabilizer for dispersions, as a dispersant, as a lubricant, as a promoter, and the like.

The viscoelastic fluid can be employed in myriad end use applications. In one embodiment, the viscoelastic fluid can be employed as an additive in the area of energy exploration and water treatment. For example, the viscoelastic fluid can be added to fluids in oil and gas hydrocarbon production applications, such as, for example, in drilling well-bores and in hydraulic fracturing applications, or other down-hole oil field applications

The viscoelastic fluid can function as a rheology control agent in a drilling mud. Drilling fluids function principally to carry chips and cuttings produced by drilling to the surface; to lubricate and cool the drill bit and drill string; to form a filter cake which obstructs filtrate invasion in the formation; to maintain the walls of the borehole; to control formation pressures and prevent lost returns; to suspend cuttings during rig shutdowns; and to protect the formation for later successful completion and production. Drilling fluids or muds are preferably able to suspend cuttings and weighting materials upon stopping of circulation of the drilling fluid. It is further desirable to have drilling fluids or muds which maintain thixotropy and rheology during operation and even in compositions with increased solids. The viscoelastic fluid can effectively assist in any of the foregoing functions.

There are two major types of drilling fluids, or muds, in use today. In addition, a somewhat different foam drilling fluid is occasionally used. The fluids are either oil-based or water-based. The oil-based fluids are generally water-in-oil emulsions which contain some water in the form of a discontinuous emulsified phase. Typically the water used contains 25 to 30 weight % calcium chloride. The oil is the continuous phase. The other major type of drilling fluids are the water-based drilling fluids. These water-based compositions may contain some oil phase. If oil is present, it exists as a discontinuous emulsified phase. Accordingly, the water-based fluids which contain oil, are oil-in-water emulsions. Since the external properties of emulsions, such as dispersability, wetting characteristics, and feel, are determined by the continuous phase, the oil-based fluids are more like oil, even though they contain water, and the water-based fluids are more like water, even though they may contain oil. In one embodiment, the viscoelastic fluid can be employed in an oil-based drilling fluid. In one embodiment the viscoelastic fluid can be employed in a water-based drilling fluid.

The drilling fluids described herein may also include a weight material in order to increase the density of the fluid. The primary purpose for such weighting materials is to increase the density of the drilling fluid so as to prevent kick-backs and blow-outs. One of skill in the art should know and understand that the prevention of kick-backs and blow-outs is important to the safe day to day operations of a drilling rig. Thus the weight material is added to the drilling fluid in a functionally effective amount largely dependent on the nature of the formation being drilled. Weight materials suitable for use in the formulation of the drilling fluids of the claimed subject matter may be generally selected from any type of weighting materials be it in solid, particulate form, suspended in solution, dissolved in the aqueous phase as part of the preparation process or added afterward during drilling. Example weight material can be selected from the group including organophillic clay, barium sulfate, hematite, iron oxide, calcium carbonate, alkali halides, alkaline earth halides, magnesium carbonate, zinc halides, zinc formates, zinc acetates, cesium halides, cesium formates, cesium acetates, as well as other well known organic and inorganic salts, and mixtures and combinations of these compounds and similar such weight materials that may be utilized in the formulation of drilling fluids.

In some embodiments, the viscoelastic fluid can be employed as a replacement for any weighting material. That is, in one embodiment the drilling fluid can contain the viscoelastic fluid and exclude weighting agents.

In addition to the components noted above, the described drilling fluids may also be formulated to include materials generically referred to as polymeric viscosifying agents, fluid loss control agents, gelling materials, thinners, and fluid loss control agents, as well as other compounds and materials which are optionally added to water based drilling fluid formulations. Of these additional materials, each can be added to the formulation in a concentration as rheologically and functionally required by drilling conditions. Typical fluid loss control agents and gelling materials used in aqueous based drilling fluids are polyanionic cellulose, carboxymethylcellulose (PAC or CMC), chemically modified starches, bentonite, sepiolite, clay, attapulgite clay, anionic high-molecular weight polymers and biopolymers. Thinners such as lignosulfonates are also often added to water-base drilling fluids. Typically lignosulfonates, modified lignosulfonates, polyphosphates and tannins are added. In other embodiments, low molecular weight polyacrylates can also be added as thinners. Thinners are added to a drilling fluid to reduce viscosity and control gelation tendencies. Other functions performed by thinners include reducing filtration and filter cake thickness, counteracting the effects of salts, minimizing the effects of water on the formations drilled, emulsifying oil in water, and stabilizing mud properties at elevated temperatures.

Other additives that could be present in the drilling fluids described herein include products such as shale inhibition agents, shale encapsulation agents, such as polyamides and glycols, lubricants, penetration rate enhancers, defoamers, corrosion inhibitors and loss circulation products. Such compounds should be known to one of ordinary skill in the art of formulating aqueous based drilling fluids.

The drilling fluids of the disclosed technology include the viscoelastic fluid described herein, present in an amount sufficient to alter or maintain the rheological properties of the fluid. In some embodiments the viscoelastic fluid can be employed at a 1:0.1 weight ratio of drilling fluid to viscoelastic fluid to about a 1:5 weight ratio. In other embodiments, the viscoelastic fluid can be employed at a 1:0.25 weight ratio of drilling fluid to viscoelastic fluid to about a 1:2.5 weight ratio, or a 1:0.5 weight ratio to about a 1:1.5 weight ratio. In further embodiments the viscoelastic fluid can be employed at a 1:0.75 weight ratio of drilling fluid to viscoelastic fluid to about a 1:1.25 weight ratio, or even a 1:1 weight ratio.

Other oil-field materials in which the viscoelastic fluid can be employed include enhanced oil recovery fluids, fracturing fluids, spotting fluids, fluid loss materials, and cementing materials.

The viscoelastic fluid can act as a dispersion stabilizer for viscosity-promoting fillers used in hydraulic fracturing fluids. Many hydraulic fracturing fluids include polymeric materials, including hydratable polymers, such as galactomannans, including guar or cassia, and modified galactomannans, such as hydroxy ethyl guar, hydroxy propyl guar, or glyceryl cassia; starches, such as carboxy methyl cellulose and hydroxy ethyl cellulose; acrylate polymers such as Carbopol™, available from Lubrizol Advanced Materials; particulates, such as clays, pigments (titanium dioxide, calcium carbonate, and other minerals), abrasives, and the like. These materials, particularly the polymers, are often stored in slurry form and pumped into the fracturing fluid as needed. Storage of the polymer slurry can result in phase separation and polymer degradation caused by the shearing required to keep the slurry re-circulating. The viscoelastic fluid can function to help suspend the polymer materials in such polymer slurries.

Slurries of the viscoelastic fluid and viscosity-promoting filler, such as guar, in oil can include the viscoelastic fluid present in an amount sufficient to alter or maintain the stability of the fluid without recirculation. In some embodiments the viscoelastic fluid can be employed at a 1:0.1 weight ratio of viscosity-promoting filler to viscoelastic fluid to about a 1:5 weight ratio. In other embodiments, the viscoelastic fluid can be employed at a 1:0.25 weight ratio of viscosity-promoting filler to viscoelastic fluid to about a 1:2.5 weight ratio, or a 1:0.5 weight ratio to about a 1:1.5 weight ratio. In further embodiments the viscoelastic fluid can be employed at a 1:0.75 weight ratio of viscosity-promoting filler to viscoelastic fluid to about a 1:1.25 weight ratio, or even a 1:1 weight ratio.

The viscoelastic fluid can also be employed, for example, in water treatment applications, such as waste water, cooling water, potable water purification, and the like, and in fluid used to clean or contain chemical spills, such as in an acid-spill absorbent, and the like.

The viscoelastic fluid can be employed in energy exploration and water treatment applications along with other additives. Other such additives can include, but not be limited to, glycols (monoethylene glycol, diethylene glycol, monopropylene glycol, dipropylene glycol, monopropylene glycol, dibutylene glycol, polyethylene glycol, polypropylene glycol, 1,6-hexane glycol, 1,8-octanediol, 1,10-decanediol, 2-methyl-1,3-propanediol, and the like), hydratable polymers, such as polysacharides, for example, liquid carrier soluble resins (styrene-isoprene copolymers, styrene ethylene-propylene block copolymers, styrene isobutylene copolymers, styrene butadiene copolymers, polybutylene, polystyrene, polyethylene-propylene copolymers, methyl methacrylate and mixtures thereof), propping agents, including solid particles or gravel (quartz sand grains, glass and ceramic beads, sintered bauxite grains, sized calcium carbonate, sized salts, walnut shell fragments, aluminum pellets, nylon pellets, and the like), other viscosifying agents, water wetting surfactants, clay stabilization additives, scale dissolvers, biopolymer degradation additives, pH buffers, biocides, surfactants, non-emulsifiers, anti-foamers, inorganic scale inhibitors, colorants, clay control agents, and other common components.

The amount of each chemical component described is presented exclusive of any solvent or diluent oil, which may be customarily present in the commercial material, that is, on an active chemical basis, unless otherwise indicated. However, unless otherwise indicated, each chemical or composition referred to herein should be interpreted as being a commercial grade material which may contain the isomers, by-products, derivatives, and other such materials which are normally understood to be present in the commercial grade.

It is known that some of the materials described above may interact in the final formulation, so that the components of the final formulation may be different from those that are initially added. For instance, metal ions (of, e.g., a detergent) can migrate to other acidic or anionic sites of other molecules. The products formed thereby, including the products formed upon employing the composition of the present invention in its intended use, may not be susceptible of easy description. Nevertheless, all such modifications and reaction products are included within the scope of the present invention; the present invention encompasses the composition prepared by admixing the components described above.

### EXAMPLES

### Example 1

Sample A—A gelling agent was prepared by blending salicylic acid, (tri(2-ethylhexyl) borate) and oleylamine in a 2:1:1 molar ratio.

Sample B—A gelling agent was prepared by blending salicylic acid, (tri(2-ethylhexyl) borate) and stearylamine in a 2:1:1 molar ratio.

Sample C—A gelling agent was prepared by blending 5-hexadecyl-2-hydroxybenzoic acid, (tri(2-ethylhexyl) borate) and oleylamine in a 2:1:1 molar ratio.

Sample D—A gelling agent was prepared by blending 5,5′-methylenebis-(2-hydroxybenzoic acid), (tri(2-ethylhexyl) borate) and oleylamine in a 2:1:1 molar ratio.

Sample E—A gelling agent was prepared by blending 2-hydroxybenzoic acid, (tri(2-ethylhexyl) borate) and a polyisobutylene succinimide in a 2:1:1 molar ratio.

### Example 2

The gelling agent of Sample A was evaluated for stability in mineral oil with a biopolymer by comparing the stability of a sample with the gelling agent to a sample without the gelling agent. The gelling agent, mineral oil and biopolymer (in this case guar) were placed in a jar and shaken at 50° C. for 1 hour, then allowed to cool to room temperature. The stability evaluation was based on the clarity of the blend and the number of phases present. Results are provided in Table 1.

TABLE 1

| Sample | | 1 | 2 |
|---|---|---|---|
| Biopolymer (g) | | 4 | 4 |
| Mineral Oil (g) | | 5.82 | 5.82 |
| Gelling Agent (g) | | 0 | 0.18 |
| Initial Ratings | Clarity | Clear Oil Upper | hazy/ |
| | | Phase/guar | homogenous |
| | | lower phase | |
| | Phases | 2 | 1 |
| After 2 days | Clarity | Clear Oil Upper | hazy/some oil |
| room temp | | Phase/guar | beginning to |
| | | lower phase | separate |
| | Phases | 2 | 1 |

### Example 3

The shear thinning properties of the gelling agent of Sample A and Sample B were evaluated in relation to the level of mineral oil in the blend and blend temperature. Sample blends 3 through 15 were placed in an Ofite™ model 900 viscometer and the viscosity of the blend was measured at different spindle speeds and temperatures. Results are provided in Table 2.

TABLE 2

| Sample | | | | | | | | | | | | |
|---|---|---|---|---|---|---|---|---|---|---|---|---|
| 3 | 4 | 5 | 6 | 7 | 8 | 9 | 10 | 11 | 12 | 13 | 14 | 15 |

Gelling Agent (wt %)

| Sample A | 0 | 1 | 2.5 | 5 | 1 | 2.5 | 5 | | | | | | |
|---|---|---|---|---|---|---|---|---|---|---|---|---|---|
| Sample B | | | | | | | | 1 | 2.5 | 5 | 1 | 2.5 | 5 |
| Mineral Oil | 100 | 99 | 97.5 | 95 | 99 | 97.5 | 95 | 99 | 97.5 | 95 | 99 | 97.5 | 95 |
| (wt %) | | | | | | | | | | | | | |
| Temp ° C. | 25 | 25 | 25 | 25 | 80 | 80 | 80 | 25 | 25 | 25 | 80 | 80 | 80 |
| Spindle Speed | | | | | | | | | | | | | |
| (rpm) | Viscosity (cP) | | | | | | | | | | | | |
| 600 | 34.4 | 39.2 | 37.3 | 43.9 | 5.4 | 5.6 | 5.4 | 34 | 33 | 26.3 | 5.1 | 5.2 | 5.8 |
| 300 | 35 | 41.3 | 39 | 46.5 | 5.7 | 5.5 | 5.2 | 34.7 | 33.7 | 26.7 | 5.1 | 5.1 | 5.8 |
| 200 | 35.2 | 42.9 | 40.3 | 48.6 | 5.4 | 6 | 5.1 | 35 | 34.1 | 27.1 | 5 | 6.7 | 7.3 |
| 100 | 35.7 | 45.4 | 42.9 | 52 | 5.4 | 5.9 | 4.9 | 35.1 | 34.1 | 27.3 | 5.3 | 5.7 | 5.6 |
| 60 | 34.7 | 45.4 | 46.3 | 55.8 | 6.1 | 7.5 | 6.4 | 34.5 | 34.1 | 29.5 | 6.8 | 7.5 | 7.1 |
| 30 | 35.4 | 57.1 | 56.1 | 62.4 | 10.3 | 9.7 | 10.7 | 33.4 | 34.8 | 29.9 | 8.2 | 12.5 | 8.2 |
| 6 | 16.4 | 119.5 | 142.3 | 108.9 | 38.5 | 27.8 | 19.9 | 32.4 | 43.3 | 37.9 | 21.8 | 25.5 | 32.9 |
| 3 | 24.4 | 211.1 | 237.1 | 193.2 | 71.6 | 50.2 | 32.6 | 44.1 | 65.3 | 65.4 | 39.3 | 47.2 | 62.1 |

### Example 4

The gelling agent of Sample A was evaluated in various different oils. Viscosity was measured using an OFITE™ Model 900 viscometer at 300 rpm and at room temperature. Results are provided in Table 3.

TABLE 3

| | Oil Viscosity | Oil + 1% Sample A |
|---|---|---|
| | cP | cP |
| mineral oil | 40.1 | 64.9 |
| Paraffinic napthenic oil | 2 | 8.6 |
| C8-C26 Fischer Tropsch oil | 3.3 | 14.2 |
| C13+ Olefin oil | 3.3 | 11.9 |
| Diesel | 3 | 10.3 |
| Synthetic paraffin oil | 1.9 | 3.4 |
| De-aromatized kerosene fractions | 2.6 | 8.5 |
| Hexane | 0.0 | 2.5 |
| Heptane | 0.0 | 2.5 |

Each of the documents referred to above is incorporated herein by reference, including any prior applications, whether or not specifically listed above, from which priority is claimed. The mention of any document is not an admission that such document qualifies as prior art or constitutes the general knowledge of the skilled person in any jurisdiction. Except in the Examples, or where otherwise explicitly indicated, all numerical quantities in this description specifying amounts of materials, reaction conditions, molecular weights, number of carbon atoms, and the like, are to be understood as modified by the word “about.” It is to be understood that the upper and lower amount, range, and ratio limits set forth herein may be independently combined. Similarly, the ranges and amounts for each element of the invention can be used together with ranges or amounts for any of the other elements.

As used herein, the transitional term “comprising,” which is synonymous with “including,” “containing,” or “characterized by,” is inclusive or open-ended and does not exclude additional, un-recited elements or method steps. However, in each recitation of “comprising” herein, it is intended that the term also encompass, as alternative embodiments, the phrases “consisting essentially of” and “consisting of,” where “consisting of” excludes any element or step not specified and “consisting essentially of” permits the inclusion of additional un-recited elements or steps that do not materially affect the essential or basic and novel characteristics of the composition or method under consideration.

While certain representative embodiments and details have been shown for the purpose of illustrating the subject invention, it will be apparent to those skilled in this art that various changes and modifications can be made therein without departing from the scope of the subject invention. In this regard, the scope of the invention is to be limited only by the following claims.

What is claimed is:

1. A slurry composition comprising a viscoelastic fluid comprising:
I) an organic medium,
II) a gelling agent comprising;
a) an organic compound chosen from at least one of:
i) an organic hydroxy acid comprising two or more oxygen atoms and hydrocarbyl substituted derivatives thereof,
ii) an aromatic polyol and hydrocarbyl substituted derivatives thereof, or
iii) combinations thereof,
b) a Lewis acid, and
c) a basic compound,
and/or the reaction product of the a), b) and c) mixture, and
III) a viscosity-promoting filler or a weighting material.

2. (canceled)

3. The slurry of claim 1, wherein the organic hydroxy acid of II) a) i) is salicylic acid or a hydrocarbyl substituted derivative thereof.

4. The slurry of claim 1, wherein the organic hydroxy acid of II) a) ii) is a formaldehyde coupled dimer of salicylic acid, or a hydrocarbyl substituted derivative thereof.

5. The slurry of claim 1, wherein the aromatic polyol of II) a) ii) is catechol or a hydrocarbyl substituted derivative thereof.

6. The slurry of claim 1, wherein the aromatic polyol of II) a) ii) is a formaldehyde coupled dimer of catechol, or a hydrocarbyl substituted derivative thereof

7. The slurry of claim 1, wherein the Lewis acid has the formula
MXₙ
where M is chromium (Cr), boron (B), aluminum (Al), titanium (Ti), silicon (Si), zirconium (Zr), or zinc (Zn),
X is a an alkoxy, hydroxyl, halogen, or hydrocarbyl halide group, and
n is an integer of from about 1 to 10.

8. The slurry of claim 1, wherein the basic compound is an organic amine.

9. The slurry of claim 1, wherein the molar ratio of a):b):c) is in the range of a) 0.1-10, b) 1, c) 0.1-10.

10. The slurry of claim 1, wherein the gelling agent of II) is present from about 0.01 to about 25% based on the weight of both I) and II) combined.

11. The slurry of claim 1 further comprising IV) further additives.

12. (canceled)

13. The slurry of claim 11, wherein the weighting material is an organophillic clay.

14. The slurry of claim 13, wherein the organophillic clay is present from about 0.1 to about 10 wt % based on the weight of I), II) and III) combined, the gelling agent of II) is present from about 0.1 to about 25 wt % based on the weight of I), II) and III) combined, and the organic medium of I) makes up the balance.

15. (canceled)

16. The slurry of claim 1, wherein the viscosity promoting filler is chosen from hydratable polymers.

17. A method of fracturing a subterranean formation comprising the steps of:
(a) providing a slurry as claimed in claim 1, and
(b) pumping the slurry through a wellbore and into a subterranean formation at sufficient pressures to fracture the formation.

18. A method of drilling a wellbore comprising the steps of:
(a) providing a slurry as claimed in claim 1, and
(b) pumping the slurry into the wellbore.

19. (canceled)

20. A method of preventing flocculation in a heterogeneous composition comprising an organic medium and a suspended additive, comprising the steps of:
providing an organic medium,
adding at least one of a viscosity promoting filler or a weighting material to the organic medium,
adding a gelling agent to the organic medium, wherein the gelling agent comprises;
a) an organic compound chosen from at least one of:
i) an organic hydroxy acid comprising two or more oxygen atoms and hydrocarbyl substituted derivatives thereof,
ii) an aromatic polyol and hydrocarbyl substituted derivatives thereof,
b) a Lewis acid, and
c) a basic compound,
and/or the reaction product of the a), b) and c) mixture.

21. The method of claim 20, wherein the viscosity promoting filler is a hydratable polymer.

22. The slurry of claim 1 wherein the viscosity-promoting filler comprises at least one of a hydratable polymer, starch, acrylate polymer, particulates, and abrasives.

23. The slurry of claim 16, wherein said hydratable polymer comprises a galactomannan or a modified galactomannan.

24. The slurry of claim 23, wherein said galactomannan is guar.
